(19) United States
(12) Patent Application Publication
(10) Pub. No.: US 2023/0123939 A1
(43) Pub. Date: Apr. 20, 2023

(54) COIL COMPONENT

(71) Applicant: TDK CORPORATION, Tokyo (JP)

(72) Inventors: Shota OTSUKA, Tokyo (JP); Takashi KUDO, Tokyo (JP); Kyohei TONOYAMA, Tokyo (JP); Taiji MATSUI, Tokyo (JP)

(73) Assignee: TDK CORPORATION, Tokyo (JP)

(21) Appl. No.: 17/964,457

(22) Filed: Oct. 12, 2022

(30) Foreign Application Priority Data
Oct. 14, 2021 (JP) 2021-168517

(51) Int. Cl. H01F 27/29; H01F 27/32; H01F 27/24; H01F 27/34; H01F 27/02

(52) U.S. Cl. CPC H01F 27/292; H01F 27/32; H01F 27/24; H01F 27/34; H01F 27/022

(57) ABSTRACT

In a coil component includes an insulating layer interposed between an external terminal and an element body and formed in an entire region excluding a connection region in a formation region in which the external terminal is formed, even when a high transient voltage is applied between the pair of external terminals, insulation breakdown does not occur or hardly occurs because of the insulating layer.

### CROSS-REFERENCE TO RELATED APPLICATIONS

This application is based upon and claims the benefit of priority from Japanese Patent Application No. 2021-168517, filed on 14 Oct. 2021, the entire contents of which are incorporated herein by reference.

### TECHNICAL FIELD

The present disclosure relates to a coil component.

### BACKGROUND

Well known in the art is a coil component in which a coil is provided in an element body made of magnetic material containing metal powder and resin. Patent Document 1 discloses a coil component including a coil having both end portions extracted to end surfaces of the element body, and a pair of external terminals respectively provided on the end surfaces of the element body and electrically connected to the end portions of the coil.

### PATENT DOCUMENTS

Patent Document 1: U.S. Patent Application Publication No. 2016/0086714

Patent Document 2: Japanese Patent Application Publication No. 2021-093468

### SUMMARY

The above-described coil component is required to have Electro-Static Discharge (ESD) resistance that does not cause insulation breakdown even when large static electricity is instantaneously applied. In particular, the ESD resistance against an extremely high transient voltage (for example, 25 kV) is required for an in-vehicle coil component.

The inventors have repeatedly studied the ESD resistance of the coil component, and have newly found a technique capable of improving the withstand voltage against the transient voltage.

According to the present disclosure, a withstand voltage against a transient voltage of a coil is improved.

A coil component according to one aspect of the present disclosure includes an element body made of a magnetic material including metal powder and resin, a coil provided in the element body, a surface of the coil is covered with an insulator, and both end portions of the coil are extracted to the surface of the element body, and a pair of external terminals provided on the surface of the element body and including connection regions connected to both end portions of the coil, and an insulating layer interposed between at least one of the external terminals and the element body and formed in an entire region excluding the connection region in a formation region where the external terminal is formed.

In the coil component, the insulating layer interposed between at least one of the external terminals and the element body prevents insulation breakdown from occurring even when a high transient voltage is applied between the pair of external terminals. Therefore, in the above-described coil component, the withstand voltage against the transient voltage is improved.

In a coil component according to another aspect, the element body has a mounting surface facing toward a mounting substrate side, the coil component is to be mounted on the mounting substrate, both end portions of the coil are extracted to the mounting surface, and at least a portion of the external terminal is provided on the mounting surface.

In a coil component according to another aspect, the element body has a mounting surface facing toward a mounting substrate side and a pair of end surfaces facing each other in one direction parallel to the mounting surface, the coil component is to be mounted on the mounting substrate, and both end portions of the coil are extracted to the pair of end surfaces, respectively, and at least a portion of the external terminal is provided on the end surface.

In a coil component according to the other aspect, an insulator covering the surface of the coil is exposed on the surface of the element body and covers an entire circumference of the end portion of the coil on the surface of the element body. The insulating layer may be in contact with the insulator at the surface of the element body.

In the coil component according to another aspect, the insulating layer covers a part of the end portion of the coil on the surface of the element body.

In the coil component according to another aspect, the end portion of the coil protrudes from the element body and extends outward from the external terminal.

### BRIEF DESCRIPTION OF THE DRAWINGS

FIG. 1 is a schematic perspective view of a coil component according to a first embodiment.

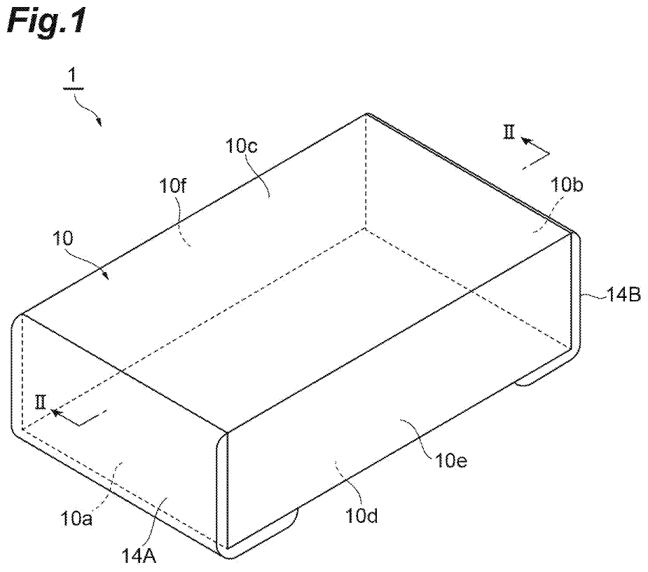

FIG. 2 is a cross-sectional view taken along line II-II of the coil component shown in FIG. 1.

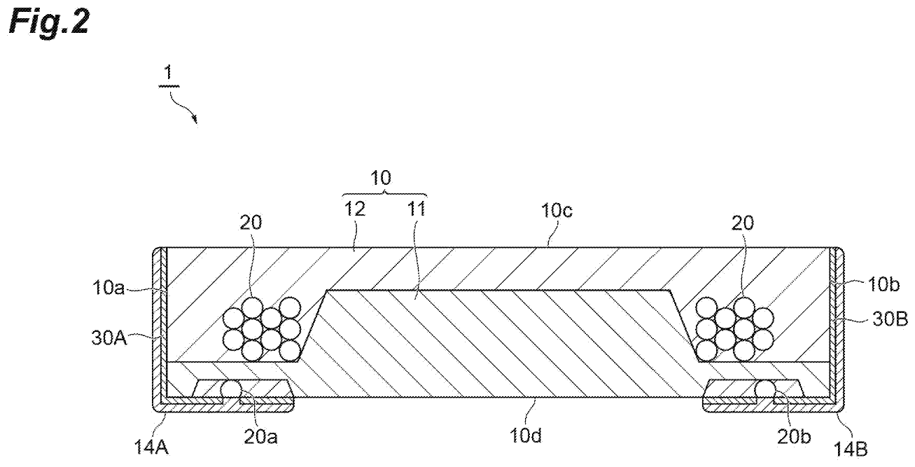

FIG. 3 is a schematic perspective view showing the lower magnetic element body of FIG. 2.

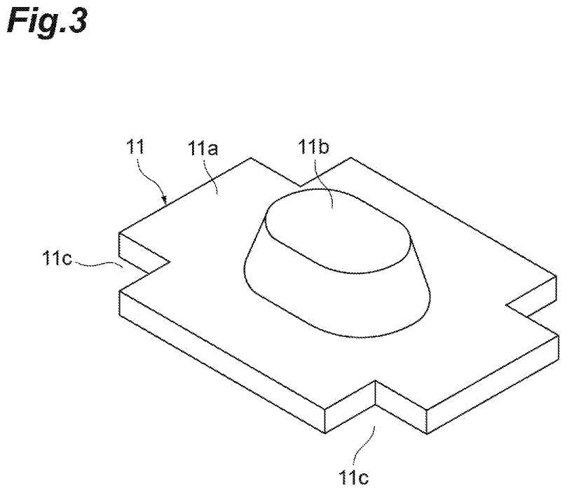

FIG. 4 is a schematic perspective view showing the coil of FIG. 2.

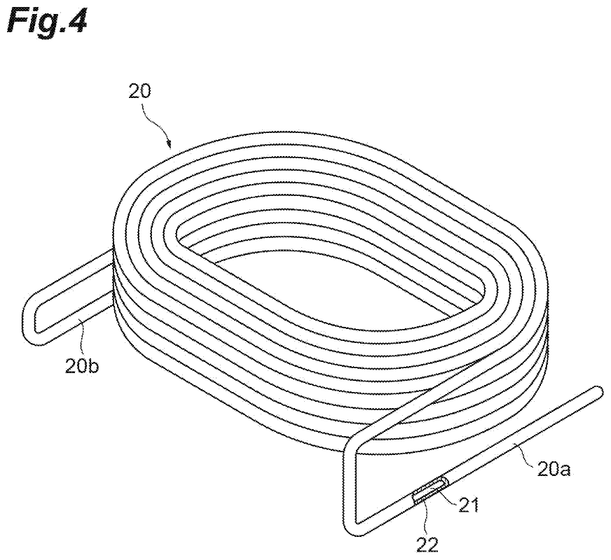

FIG. 5 is a view showing a lower surface of the element body of FIG. 1.

FIG. 6 is an enlarged view of a main part of the cross-sectional view of FIG. 2.

FIG. 7 is a schematic perspective view of a coil component according to a second embodiment.

FIG. 8 is a cross-sectional view taken along line VIII-VIII of the coil component shown in FIG. 7.

FIG. 9 is a view showing an end face of the element body of FIG. 7.

FIG. 10 is an enlarged view of a main part of the cross-sectional view of FIG. 8.

FIG. 11 is a schematic perspective view of a coil component according to a third embodiment.

FIG. 12 is a cross-sectional view taken along line XII-XII of the coil component shown in FIG. 11.

FIG. 13 is an exploded perspective view of the element body shown in FIG. 11.

FIG. 14 is a view showing an end face of the element body of FIG. 11.

FIG. 15 is an enlarged view of a main part of the cross-sectional view of FIG. 12.

FIG. 16 is a schematic perspective view of a coil component according to a fourth embodiment.

FIG. 17 is an exploded perspective view of the element body shown in FIG. 16.

FIG. 18 is a cross-sectional view taken along line XVIII-XVIII of the coil component shown in FIG. 16.

FIG. 19 is a view showing an end face of the element body of FIG. 16.

FIG. 20 is an enlarged view of a main part of the cross-sectional view of FIG. 18.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

### (First Embodiment)

The coil component 1 according to the first embodiment includes an element body 10, a coil 20 embedded in the element body 10, and a pair of external terminals 14A and 14B provided on the element body 10.

The element body 10 has a substantially rectangular parallelepiped outer shape and includes six surfaces 10a to 10f. As an example, the element body 10 is designed to have dimensions of long side 2.5 mm, short side 2.0 mm, and 1.2 mm height. Of the surfaces 10a to 10f of the element body 10, the end surface 10a and the end surface 10b are parallel to each other, the upper surface 10c and the lower surface 10d are parallel to each other, and the side surface 10e and the side surface 10f are parallel to each other. The lower surface 10d of the element body 10 is a mounting surface facing in parallel to a mounting surface of a mounting substrate on which the coil component 1 is mounted.

The element body 10 includes a lower magnetic element body 11 and an upper magnetic element body 12. The lower magnetic element body 11 and the upper magnetic element body 12 are made of a metal magnetic powder-containing resin, which is one type of magnetic material. The magnetic metal powder-containing resin is a binder powder in which magnetic metal powder is bound by a binder resin. The metal magnetic powder of the metal magnetic powder-containing resin contains, for example, iron, and is composed of an alloy-based material such as permalloy, sendust, FeSiCr, FeSi, carbonyl iron, an amorphous alloy, or a nanocrystal. The binder resin is, for example, a thermosetting epoxy resin. In the present embodiment, the content of the magnetic metal powder in the binder powder is 75 to 92 vol % in terms of volume percent, and 95 to 99 wt % in terms of weight percent. From the viewpoint of magnetic properties, the content of the magnetic metal powder in the binder powder may be 80 to 92 vol % in terms of volume percent and 97 to 99 wt % in terms of weight percent.

The lower magnetic element body 11 has a flat plate part 11a and a projecting part 11b, and the coil 20 is placed on the flat plate part 11a so that the projecting part 11b is inserted into the inside diameter part of the coil 20. Therefore, the lower magnetic element body 11 is located in the lower region and the inner diameter region of the coil 20. The flat plate portion 11 a is provided with an opening portion 11c through which end portions 20a and 20b of the coil 20 are extracted to the lower surface 10d of the element body 10 located below the flat plate portion 11a.

The upper magnetic element body 12 is a portion in which the coil 20 placed on the lower magnetic element body 11 is embedded. Therefore, the upper magnetic element body 12 is located in the upper region and the outer region of the coil 20. Although not particularly limited, in the present embodiment, the projecting part 11b has a tapered shape, and thus, when the lower magnetic element body 11 is molded using a mold, the projecting part 11b is easily removed from the mold.

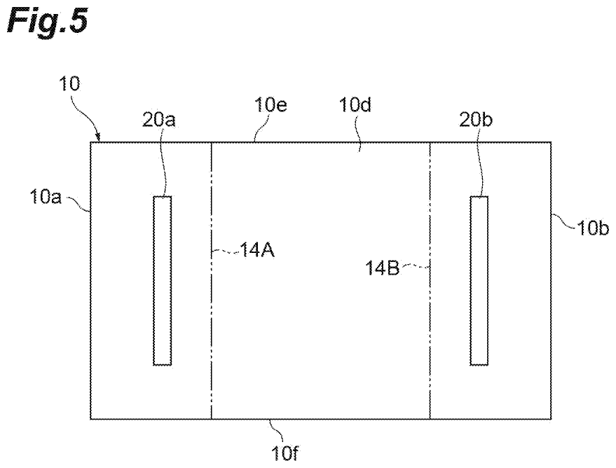

The coil 20 is embedded in the element body 10. The coil 20 is formed of a wire-shaped coated conductive wire in which a core material 21 made of Cu or the like is coated with an insulating coating 22 (insulator). In the present embodiment, one coil 20 is wound a plurality of times around the projecting part 11b. As shown in FIG. 5, one end portion 20a and the other end portion 20b of the coil 20 are exposed on the lower surface 10d of the element body 10 so as to extend in a direction parallel to the end surfaces 10a and 10b. The insulating coating 22 is removed from each of the end portions 20a and 20b of the coil 20 by polishing or the like, and the core material 21 is exposed in the lower surface 10d. One end portion 20a and the other end portion 20b of the coil 20 are respectively connected to a portion of the external terminals 14A and 14B, which covers the lower surface 10d of the element body 10. The coil 20 may be a round wire having a circular cross-section or a rectangular wire having a rectangular cross-section.

Each of the external terminals 14A and 14B is bent in an L shape and continuously covers the end surfaces 10a and 10b and the lower surface 10d. The external terminal 14A covers the entire region of the end surface 10a and a partial region of the lower surface 10d (specifically, a rectangular region extending along an edge on the end surface 10a side). The external terminal 14B covers the entire region of the end surface 10b and a partial region of the lower surface 10d (specifically, a rectangular region extending along an edge on the end surface 10b side). Portions of the external terminals 14A and 14B that cover the lower surface 10d cover the end portions 20a and 20b of the coil 20 exposed to the lower surface 10d.

In the present embodiment, the external terminals 14A and 14B are resin electrodes made of, for example, Ag powder containing resin.

The external terminals 14A and 14B can be formed by metal plating. The external terminals 14A and 14B may have a single-layer structure or a multi-layer structure.

The external terminals 14A and 14B do not directly cover the surfaces of the element body 10, but indirectly cover the surfaces of the element body 10 via the insulating layers 30A and 30B. The insulating layer 30A is provided so as to directly cover the element body 10 in the region where the external terminal 14A is formed. The insulating layer 30A is provided over the entire formation region of the external terminal 14A except for a connection region R described later. Similarly, the insulating layer 30B is provided so as to directly cover the element body 10 in the region where the external terminal 14B is formed. The insulating layer 30B is provided over the entire formation region of the external terminal 14B except for a connection region R described later.

The insulating layers 30A and 30B may be made of resin such as epoxy resin. The thicknesses of the insulating layers 30A and 30B are, for example, 10 nm to 100 μm.

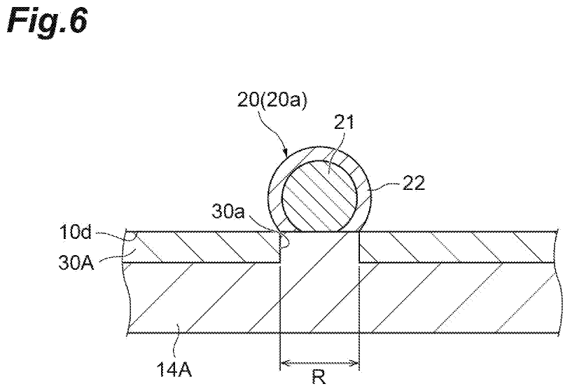

As shown in FIG. 6, an opening 30a is provided in the insulating layers 30A and 30B. The opening 30a is provided in a part or entire of an exposed region where the end portions 20a and the 20b of the coil 20 are exposed in the lower surface 10d. The opening 30a can be formed by removing the insulating layers 30A and 30B by laser irradiation or the like after forming the insulating layers 30A and 30B on the element body 10. The external terminals 14A and 14B provided on the insulating layers 30A and 30B enter the opening 30a and reach the end portions 20a and 20b of the coil 20 exposed to the lower surface 10d, and are electrically connected to the end portions 20a and 20a. That is, the region in which the opening 30a is formed corresponds to the connection region R in which the end portions 20a and 20b of the coil 20 and the external terminals 14A and 14B are connected.

The inventors have found that high ESD resistance can be obtained by a configuration in which the insulating layers 30A and 30B are interposed between the external terminals 14A and 14B and the element body 10 in the entire region except for the connection region R in the formation region in which the external terminals 14A and 14B are formed as described above. The inventors prepared 100 coil components in which the insulating layers 30A and 30B were not provided, 100 coil components in which the pair of insulating layers 30A and 30B were provided, and 100 coil components in which only one insulating layer 30A was provided, applied a voltage of 25 kV as a transient voltage for 1 nanosecond, and checked the occurrence rate (defect rate) of insulation breakdown. As a result, the occurrence rate of insulation breakdown was 100% in the coil component in which the insulating layers 30A and 30B were not provided, whereas the occurrence rate of insulation breakdown was 0% in the coil component in which the pair of insulating layers 30A and 30B were provided and the coil component in which only one insulating layer 30A was provided. From these results, it was confirmed that, by interposing the insulating layers 30A and 30B between at least one of the external terminals 14A and 14B and the element body 10, a situation in which the external terminals 14A and 14B are short-circuited via the element body 10 is suppressed, and ESD resistance against the transient voltage having a height of about 25 kV can be realized.

The inventors prepared a coil component in which the insulating layers 30A and 30B cover regions other than the regions where the external terminals 14A and 14B are formed, and performed a similar test. However, it was confirmed that the insulating layers covering regions other than the regions where the external terminals 14A and 14B are formed did not affect the rate of occurrence of insulation breakdown. That is, as long as the insulating layers 30A and 30B are located in the regions where the external terminals 14A and 14B are formed, the withstand voltage against the transient voltage is improved.

As described above, the coil component 1 includes the insulating layers 30A and 30B respectively interposed between the external terminals 14A and 14B and the element body 10 and formed in the entire region excluding the connection region in the formation region in which the external terminals 14A and 14B are formed. In the coil component 1, the external terminals 14A and 14B are not in direct contact with the element body 10 due to the insulating layers 30A and 30B. Even when a high transient voltage (25 kV in the present embodiment) is applied between the pair of external terminals 14A and 14B, insulation breakdown does not occur or hardly occurs. Therefore, in the coil component 1, an improvement in withstand voltage against a transient voltage is realized.

Both of the insulating layers 30A and 30B may be provided as in the embodiment described above, or only one of them (the insulating layer 30A or the insulating layer 30B) may be provided.

The insulating layers 30A and 30B may cover part or all of the insulating coatings 22 of the end portions 20a and 20b of the coil 20 exposed to the lower surface 10d of the element body 10. In addition, the insulating layers 30A and 30B may cover a part of the core material 21 of the end portions 20a and 20b of the coil 20 exposed to the lower surface 10d of the element body 10 as long as conduction with the coil 20 is achieved. In a configuration in which the insulating layers 30A and 30B cover the insulating coating 22 (or the insulating coating 22 and the core material 21) of the end portions 20a and 20b of the coil 20, positional deviation of the openings 30a of the insulating layers 30A and 30B can be allowed to some extent, and even if positional deviation occurs to some extent, direct contact between the external terminals 14A and 14B and the element body 10 can be avoided.

### (Second Embodiment)

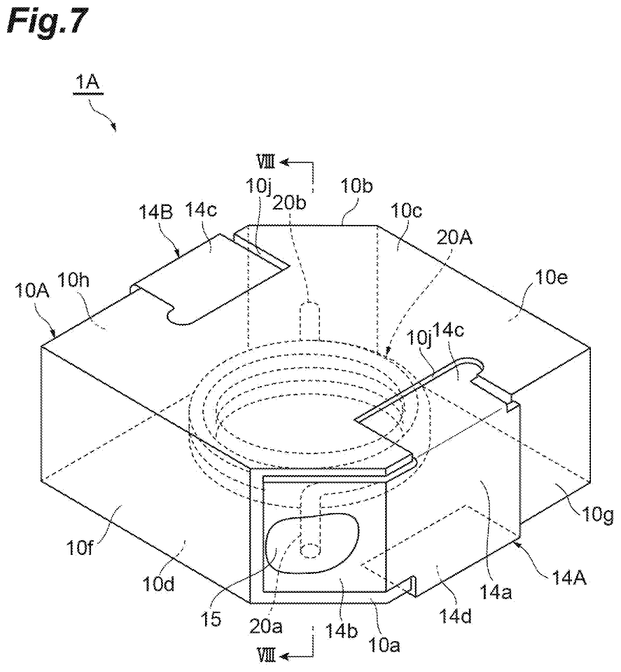

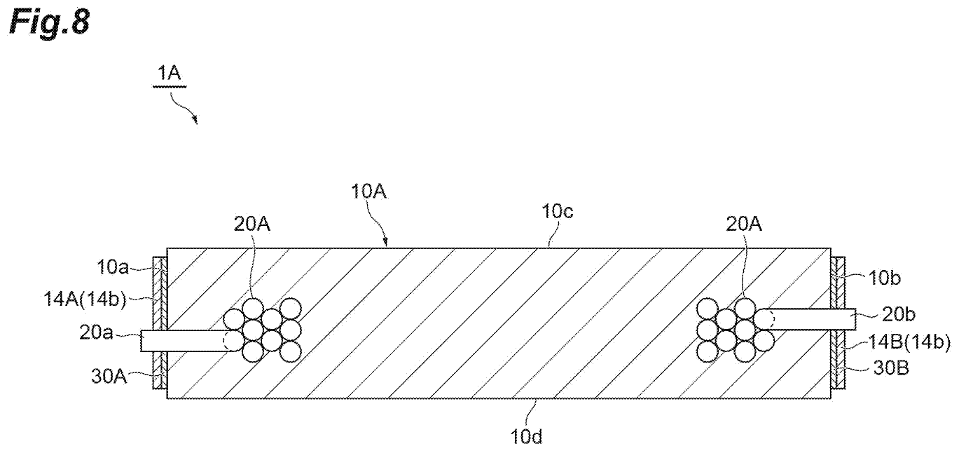

As shown in FIGS. 7 and 8, the coil component 1A according to the second embodiment is different from the above-described coil component 1 in the outer shape of the element body 10A, the shape of the coil 20A embedded in the element body 10A, and the shapes of a pair of external terminals 14A and 14B provided on the surfaces of the element body 10A, and is identical or similar to the coil component 1 in other configurations. The external terminals 14A and 14B in the present embodiment are terminal metal parts, for example.

The element body 10A has eight surfaces 10a to 10h. Of the surfaces 10a to 10h of the element body 10A, the upper surface 10c and the lower surface 10d are parallel to each other, the side surface 10e and the side surface 10f are parallel to each other, the side surface 10g and the side surface 10h are parallel to each other, the end surface 10a and the end surface 10b are parallel to each other, and the side surface 10e and the side surface 10f are parallel to each other. A portion between the side surface 10f and the side surface 10g is chamfered, whereby an end surface 10f is formed between the side surface 10g and the side surface 10a. Similarly, a chamfer is formed between the side surface 10e and the side surface 10h, thereby forming an end surface 10e between the side surface 10h and the side surface 10b. The lower surface 10d of the element body 10A is a surface facing in parallel to the mounting surface of the mounting substrate on which the coil component 1A is mounted.

Recesses 10i and 10j are formed in the upper surface 10c of the element body 10A. The recess 10i is formed from a ridge line formed by the side surface 10g and the upper surface 10c toward the center of the upper surface 10c. The recess 10j is formed from a ridge line formed by the side surface 10h and the upper surface 10c toward the center of the upper surface 10c.

One external terminal 14A of the pair of external terminals 14A and 14B includes a base portion 14a, a joint portion 14b, one clamping portion 14c, and the other clamping portion 14d. The base portion 14a of the external terminal 14A is disposed along the side surface 10g of the element body 10A. The joint portion 14b of the external terminal 14A extends from the base portion 14a and is disposed along the end surface 10a of the element body 10A. A fusion portion 15 is formed in the joint portion 14b, and one end portion 20a of the coil 20A and the external terminal 14A are joined by welding in the fusion portion 15. The clamping portion 14c of the external terminal 14A extends from the base portion 14a and is disposed along the recess 10i formed in the upper surface 10c of the element body 10A. The clamping portion 14d of the external terminal 14A extends from the base portion 14a and is disposed along the lower surface 10d.

Of the pair of external terminals 14A and 14B, the other external terminal 14B has the same configuration as the external terminal 14A. That is, the other external terminal 14B includes a base portion 14a, a joint portion 14b, one clamping portion 14c, and the other clamping portion 14d. The base portion 14a of the external terminal 14B is disposed along the side surface 10h of the element body 10A. The joint portion 14b of the external terminal 14B extends from the base portion 14a and is disposed along the end surface 10b of the element body 10A. A fusion portion 15 is formed in the joint portion 14b, and the other end portion 20b of the coil 20A and the external terminal 14B are joined by welding in the fusion portion 15. The clamping portion 14c of the external terminal 14B extends from the base portion 14a and is disposed along the recess 10j formed in the upper surface 10c of the element body 10A. The clamping portion 14d of the external terminal 14B extends from the base portion 14a and is disposed along the lower surface 10d.

In the coil component 1A, the pair of external terminals 14A and 14B cover partial regions of the end surfaces 10a and 10b of the element body 10A, respectively. Also in the coil component 1A, the external terminals 14A and 14B do not directly cover the surfaces of the element body 10A, but indirectly cover the surfaces of the element body 10A via the insulating layers 30A and 30B. The insulating layer 30A is provided so as to directly cover the element body 10A in the region where the external terminal 14A is formed. The insulating layer 30A is provided over the entire formation region of the external terminal 14A except for the connection region R. Similarly, the insulating layer 30B is provided so as to directly cover the element body 10A surfaces of the regions where the external terminals 14B are formed. The insulating layer 30B is provided over the entire formation region of the external terminal 14B except for the connection region R.

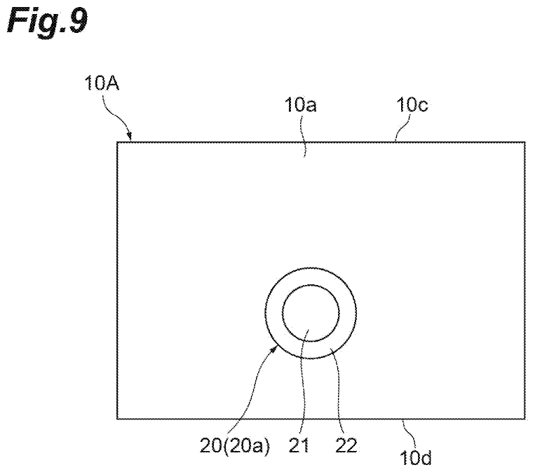

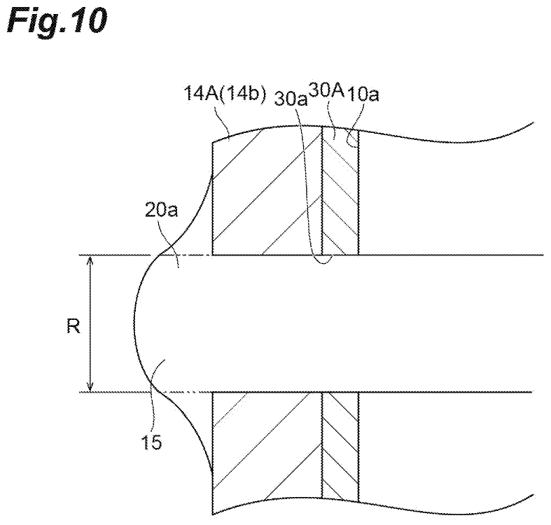

In the coil component 1A, both end portions 20a and 20b of the coil 20A are drawn out to the end surfaces 10a and 10b of the element body 10A, respectively, and protrude from the end surfaces 10a and 10b in a direction intersecting (in the present embodiment, a direction orthogonal to) the end surfaces 10a and 10b of the element body 10A. As shown in FIG. 9, in both end portions 20a and 20b of the coil 20A, the insulating coating 22 covers the entire periphery of the core material 21 of the end portions 20a and 20b in the end surfaces 10a and 10b of the element body 10A. In addition, both end portions 20a and 20b of the coil 20A pass through the external terminals 14A and 14B and the insulating layers 30A and 30B provided on the end surface 10a and 10b, and extend to the outer side of the external terminals and 14A 14B. That is, the insulating layers 30A and 30B are provided with through holes 30a that are penetrated by the end portions 20a and 20b of the coil 20. The end portions 20a and 20b are electrically connected to the external terminals 14A and 14B by welding as shown in FIG. 10, for example. In the coil component 1A, a region in which the through hole 30a is formed corresponds to a connection region R in which the end portions 20a and 20b of the coil 20A and the external terminals 14A and 14B are connected.

Similar to the coil component 1, since the coil component 1A includes the insulating layers 30A and 30B interposed between the external terminals 14A and 14B and the element body 10A and formed in the entire region excluding the connection region R in the formation region in which the external terminals 14A and 14B are formed, the withstand voltage against the transient voltage is improved.

Both of the insulating layers 30A and 30B may be provided as in the embodiment described above, or only one of them (the insulating layer 30A or the insulating layer 30B) may be provided.

### (Third Embodiment)

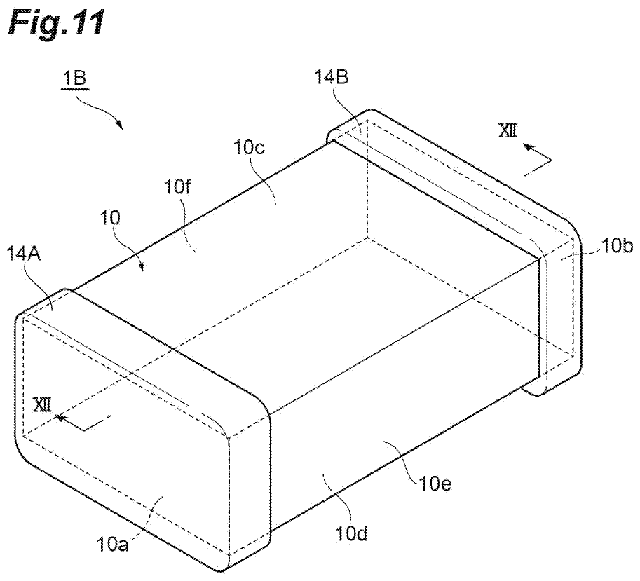

In the coil component 1B according to the third embodiment, as shown in FIGS. 11 to 13, a coil 20B embedded in an element body 10 and a pair of external terminals 14A and 14B provided on surfaces of the element body 10 are different from those of the coil component 1 according to the above-described first embodiment, and other configurations are identical or similar to those of the coil component 1.

In the coil component 1B, the pair of external terminals 14A and 14B respectively cover the entire regions of the end surfaces 10a and 10b of the element body 10. Each of the external terminals 14A and 14B includes a portion that covers the upper surface 10c, the lower surface 10d, and the side surfaces 10e and 10f near the end surfaces 10a and 10b, and these portions extend continuously from the portion that covers the end surfaces 10a and 10b.

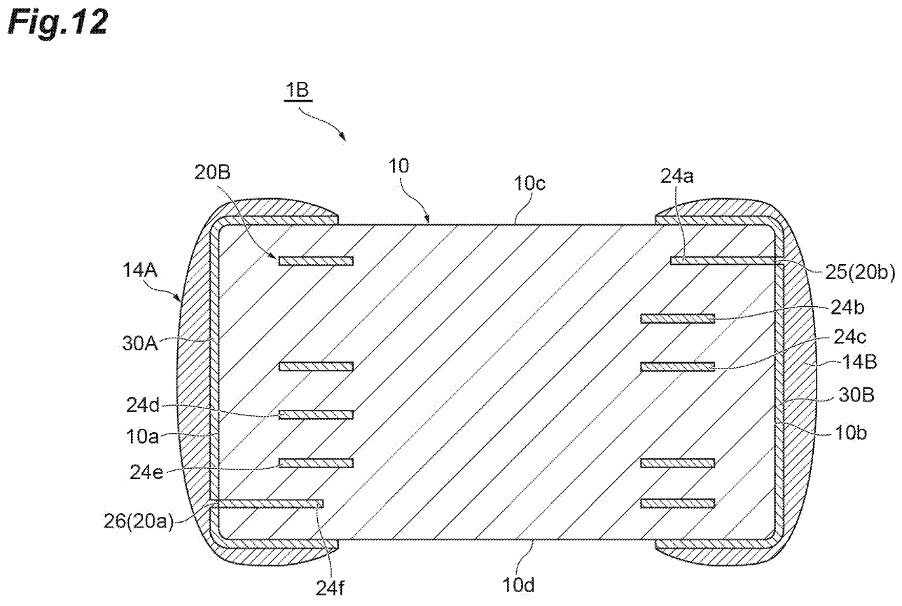

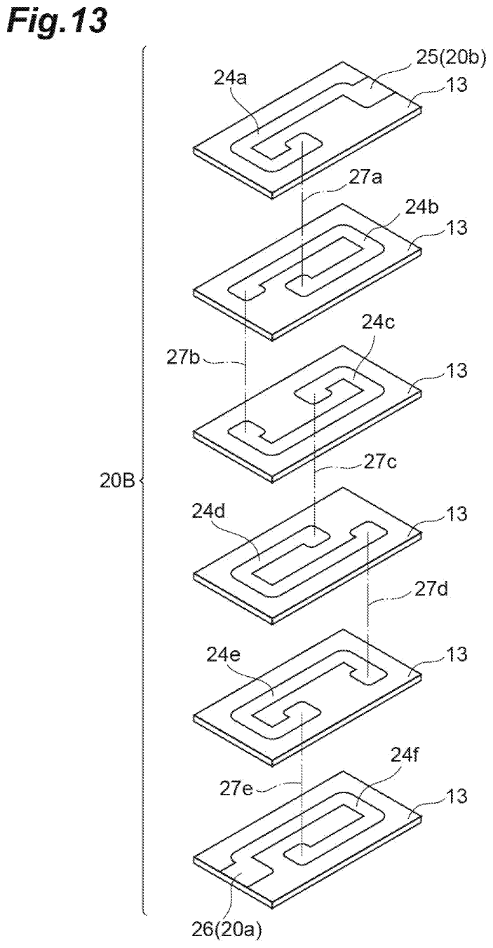

As shown in FIGS. 12 and 13, the coil 20B is configured including a plurality of coil conductors 24a to 24f. The plurality of coil conductors 24a to 24f contain a conductive material (for example, Ag or Pd), and can be formed by, for example, firing a conductive paste containing conductive material (for example, Ag powder or Pd powder). The plurality of coil conductors 24a to 24f are provided side by side in the vertical direction in the element body 10. Specifically, the coil conductor 24a, the coil conductor 24b, the coil conductor 24c, the coil conductor 24d, the coil conductor 24e, and the coil conductor 24f are arranged in this order from the top.

The coil conductor 24a includes a connection conductor 25 constituting an end portion 20b of the coil 20B. The connection conductor 25 is disposed on the end surface 10a side of the element body 10 and has an end portion exposed to the end surface 10b. An end portion of the connection conductor 25 is exposed at a position close to the upper surface 10c in the end surface 10b and is connected to the external terminal 14B. That is, the coil 20B is electrically connected to the external terminal 14B via the connection conductor 25. In the present embodiment, the conductor pattern of the coil conductor 24a and the conductor pattern of the connection conductor 25 are integrally and continuously formed. The coil conductor 24f includes a connection conductor 26 constituting an end portion 20a of the coil 20B. The connection conductor 26 is disposed on the end surface 10a side of the element body 10 and has an end portion exposed to the end surface 10a. An end portion of the connection conductor 26 is exposed at a position close to the lower surface 10d in the end surface 10a and is connected to the external terminal 14A. That is, the coil 20B is electrically connected to the external terminal 14A via the connection conductor 26. In the present embodiment, the conductor pattern of the coil conductor 24f and the conductor pattern of the connection conductor 26 are integrally and continuously formed.

End portions of the coil conductors 24a to 24f are connected to each other via through-hole conductors 27a to 27e penetrating through the magnetic layers 13 made of magnetic material constituting the element body 10. The coil conductors 24a to 24f are electrically connected to each other via the through-hole conductors 27a to 27e. The coil 20B is configured by electrically connecting a plurality of coil conductors 24a to 24f. Each of the through-hole conductors 27a to 27e includes conductive material (for example, Ag or Pd). Similarly to the plurality of coil conductors 24a to 24f, each of the through-hole conductors 27a to 27e is configured as a sintered body of a conductive paste containing conductive material (for example, Ag powder or Pd powder).

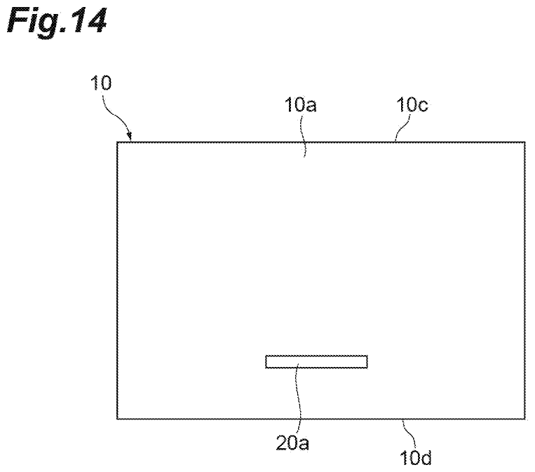

In the coil component 1B, both end portions 20a and 20b of the coil 20B are extracted to end surfaces 10a and 10b of the element body 10, respectively. Both end portions 20a and 20b of the coil 20B extend in a direction intersecting (in the present embodiment, a direction orthogonal to) the end surfaces 10a and 10b of the element body 10 and are exposed from the end surfaces 10a and 10b as illustrated in FIG. 14.

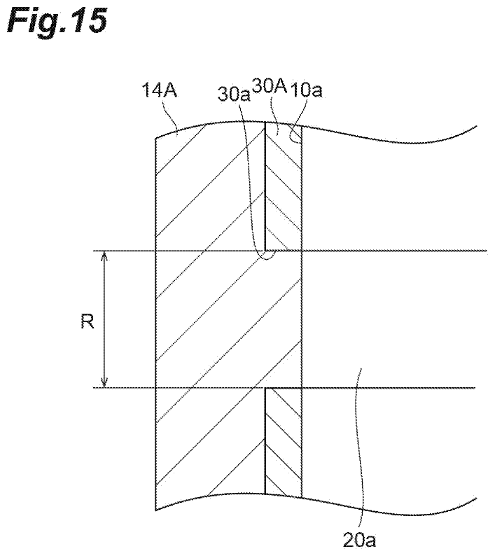

As shown in FIG. 15, an opening 30a is provided in the insulating layers 30A and 30B. The opening 30a is provided in a part or all of an exposed region in which the end portion 20a and the 20b of the coil 20B are exposed in the end surfaces 10a and 10b. The opening 30a can be formed by removing the insulating layers 30A and 30B by laser irradiation or the like after forming the insulating layer 30A and 30B on the element body 10. The external terminals 14A and 14B provided on the insulating layers 30A and 30B extend into the opening 30a to reach the end portions 20a and 20b of the coil 20B exposed to the end surfaces 10a and 10b, so as to be electrically connected to the end portions 20a and 20b. That is, the region in which the opening 30a is formed corresponds to the connection region R in which the end portions 20a and 20B of the coil 20B and the external terminals 14A and 14B are connected.

Since the coil component 1B includes the insulating layers 30A and 30B interposed between the external terminals 14A and 14B and the element body 10, respectively, and formed in the entire region excluding the connection region R in the formation region in which the external terminals 14A and 14B are formed, the withstand voltage against the transient voltage is improved in the coil component 1B, similarly to the coil components 1 and 1A.

Both of the insulating layers 30A and 30B may be provided as in the embodiment described above, or only one of them (the insulating layer 30A or the insulating layer 30B) may be provided.

### (Fourth Embodiment)

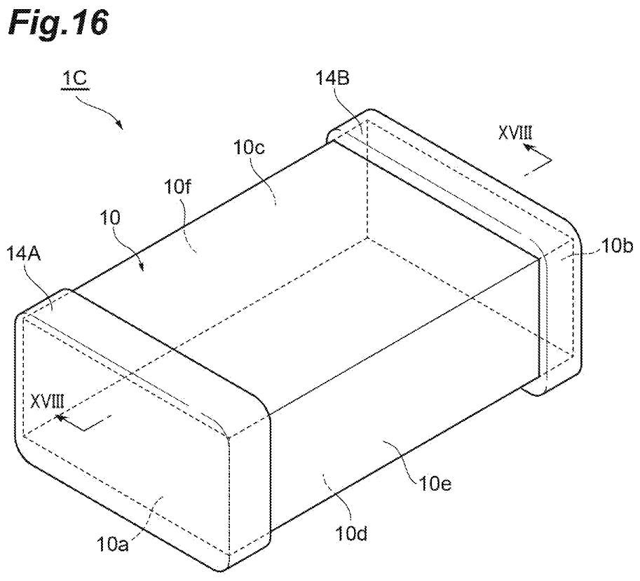

In the coil component 1C according to the fourth embodiment, as shown in FIGS. 16 to 18, the coil 20C embedded in the element body 10 is different from the coil component 1B according to the third embodiment described above, and the other configurations are identical or similar to those of the coil component 1B.

The coil 20C and an insulating substrate 40 are embedded in the element body 10 of the coil component 1C.

The insulating substrate 40 (insulator) is a plate-like member made of a non-magnetic insulating material and has a substantially elliptical annular shape when viewed from the thickness direction thereof. An elliptical through hole 40c is provided in a central portion of the insulating substrate 40. As the insulating substrate 40, a substrate in which glass cloth is impregnated with an epoxy resin can be used. In addition to the epoxy resin, BT resin, polyimide, aramid, or the like may be used. Ceramic or glass can also be used as the material of the insulating substrate 40. The insulating substrate 40 may be a mass-produced printed circuit board material, or may be a plastic material used for a BT printed circuit board, a FR4 printed circuit board, or a FR5 printed circuit board.

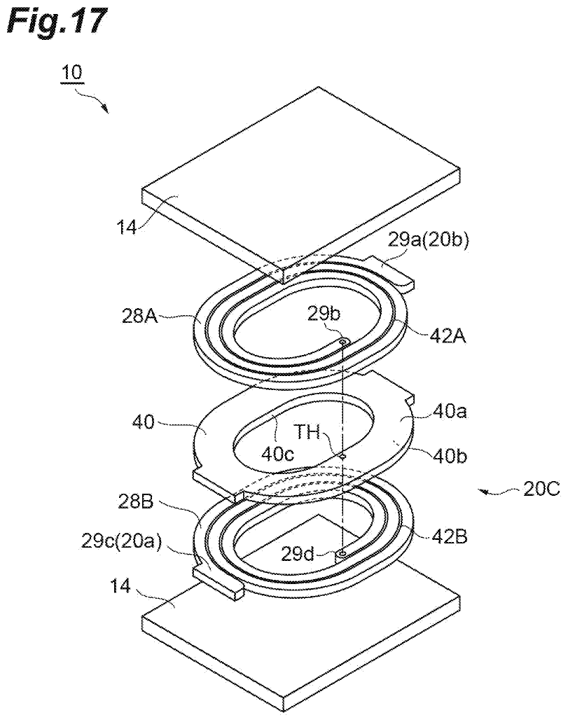

The coil 20C includes a first coil portion 28A insulation-coated of a first conductor pattern 29A for a planar air-core coil provided on one surface 40a (upper surface in FIG. 17) of the insulating substrate 40, a second coil portion 28B insulation-coated of a second conductor pattern 29B for a planar air-core coil provided on the other surface 40b (lower surface in FIG. 17) of the insulating substrate 40, and a through-hole conductor TH connecting the first conductor pattern 29A and the second conductor pattern 29B.

The first conductor pattern 29A is a planar spiral pattern serving as a planar air-core coil and is formed by plating with conductor material such as Cu. The first conductor pattern 29A is formed so as to be wound around the through hole 40c of the insulating substrate 40. More specifically, the first conductor pattern 29A is wound clockwise by three turns toward the outer side when viewed from above. The height of the first conductor pattern 29A is constant over the entire length of the insulating substrate 40. An outer end portion 29a of the first conductor pattern 29A is exposed at the end surface 10b of the element body 10 and is connected to the external terminal 14B covering the end surface 10b. An inner end portion 29b of the first conductor pattern 29A is connected to the through-hole conductor TH.

Similar to the first conductor pattern 29A, the second conductor pattern 29B is also a planar spiral pattern serving as a planar air-core coil and is formed by plating with a conductor material such as Cu. The second conductor pattern 29B is also formed so as to be wound around the through hole 40c of the insulating substrate 40. More specifically, the second conductor pattern 29B is wound counterclockwise by three turns toward the outside when viewed from the upper direction. That is, the second conductor pattern 29B is wound in a direction opposite to the first conductor pattern 29A when viewed from above. The height of the second conductor pattern 29B is the same over the entire length, and can be designed to be the same as the height of the first conductor pattern 29A. An outer end portion 29c of the second conductor pattern 29B is exposed at the end surface 10a of the element body 10 and is connected to an external terminal 14A covering the end surface 10a. An inner end portion 29d of the second conductor pattern 29B is aligned with the inner end portion 29b of the first conductor pattern 29A in the thickness direction of the insulating substrate 40, and is connected to the through-hole conductor TH.

The through-hole conductor TH is provided to penetrate an edge region of the through-hole 40c of the insulating substrate 40, and connects the end portion 29b of the first conductor pattern 29A and the end portion 29d of the second conductor pattern 29B. The through-hole conductor TH can be formed of a hole provided in the insulating substrate 40 and conductive material (for example, metal material such as Cu) filled in the hole. The through-hole conductor TH has a substantially columnar or substantially prismatic outer shape extending in the thickness direction of the insulating substrate 40.

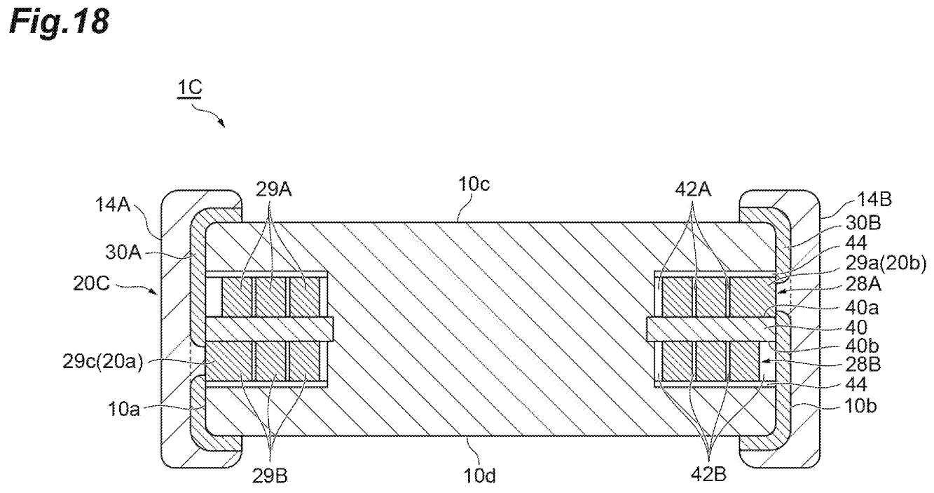

As shown in FIG. 18, the first coil portion 28A and the second coil portion 28B have resin walls 42A and 42B (insulators), respectively.

The resin wall 42A of the first coil portion 28A is located between the lines of the first conductor pattern 29A, on the inner periphery, and on the outer periphery. Similarly, the resin wall 42B of the second coil portion 28B is located between the lines of the second conductor pattern 29B, on the inner periphery, and on the outer periphery. In the present embodiment, the resin walls 42A and 42B located on the inner periphery and the outer periphery of the conductor patterns 29A and 29B are designed to be thicker than the resin walls 42A and 42B located between the lines of the conductor patterns 29A and 29B.

The resin walls 42A and 42B are made of insulating resin material. The resin walls 42A and 42B can be provided on the insulating substrate 40 before the first conductor pattern 29A and the second conductor pattern 29B are formed. In this case, the first conductor pattern 29A and the second conductor pattern 29B are plated and grown between the walls defined by the resin walls 42A and 42B. The resin walls 42A and 42B can be provided on the insulating substrate 40 after the first conductor pattern 29A and the second conductor pattern 29B are formed. In this case, the resin walls 42A and 42B are provided on the first conductor pattern 29A and the second conductor pattern 29B by filling, coating, or the like.

The first coil portion 28A and the second coil portion 28B each include an insulating layer 44 (insulator) that integrally covers the first conductor pattern 29A and the second conductor pattern 29B and the resin walls 42A and 42B from the upper surface side. The insulating layer 44 may be made of insulating resin or insulating magnetic material.

The magnetic materials constituting the element body 10 integrally cover the coil 20C and the insulating substrate 40. More specifically, the magnetic materials constituting the element body 10 cover the coil 20C and the insulating substrate 40 from above and below, and cover the outer peripheries of the coil 20C and the insulating substrate 40. The magnetic materials constituting the element body 10 fill the inside of the through-hole 40c of the insulating substrate 40 and the inner region of the coil 20C.

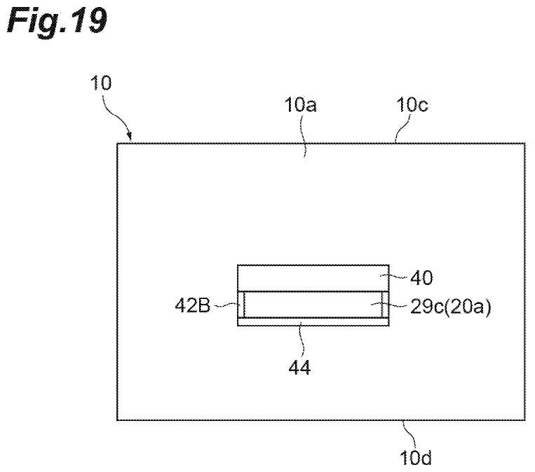

In the coil component 1C, the end portion 29c on the outer side of the second conductor pattern 29B corresponds to the end portion 20a of the coil 20C, and the end portion 29a on the outer side of the first conductor pattern 29A corresponds to the end portion 20b of the coil 20C. Both end portions 20a and 20b of the coil 20C are extracted to end surfaces 10a and 10b of the element body 10, respectively. Both end portions 20a and 20b of the coil 20C extend in a direction intersecting (in the present embodiment, a direction orthogonal to) the end surfaces 10a and 10b of the element body 10 and are exposed from the end surfaces 10a and 10b as illustrated in FIG. 19.

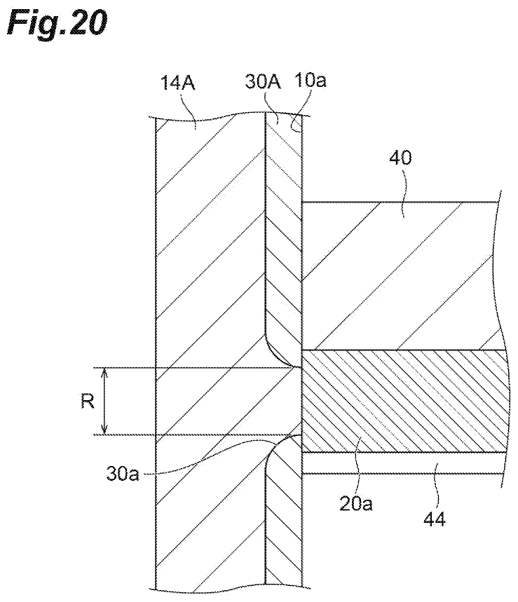

As shown in FIG. 20, an opening 30a is provided in the insulating layers 30A and 30B. The opening 30a is provided in a part or all of an exposed region in which the end portions 20a and 20b of the coil 20C are exposed in the end surfaces 10a and 10b. The opening 30a can be formed by removing the insulating layers 30A and 30B by laser irradiation or the like after forming the insulating layers 30A and 30B on the element body 10. The external terminals 14A and 14B provided on the insulating layers 30A and 30B extend into the opening 30a to reach the end portions 20a and 20b of the coil 20C exposed to the end surfaces 10a and 10b, so as to be electrically connected to the end portions 20a and 20b.

In the present embodiment, the insulating layers 30A and 30B cover the insulating substrate 40 and the insulating layer 44 located above and below the end portions 20a and 20b of the coil 20C, and cover a portion of the end portions 20a and 20b of the coil. 20C. Therefore, the connection region R is narrower than the region where the opening 30a is formed, and is a region where the end portions 20a and 20b of the coil 20C and the external terminals 14A and 14B are actually connected. By designing the insulating layers 30A and 30B so as to cover parts of the end portions 20a and 20b of the coil 20C, the positional deviation of the openings 30a of the insulating layers 30A and 30B can be allowed to some extent, and even if the positional deviation occurs to some extent, it is possible to avoid a situation in which the external terminals 14A and 14B are in direct contact with the element body 10.

Similar to the coil component 1, 1A, and 1B, the coil component 1C includes the insulating layers 30A and 30B that are respectively interposed between the external terminals 14A and 14B and the element body 10 and are formed in the entire region excluding the connection region R in the formation region in which the external terminals 14A and 14B are formed. Therefore, the withstand voltage against the transient voltage is improved.

Both of the insulating layers 30A and 30B may be provided as in the embodiment described above, or only one of them (the insulating layer 30A or the insulating layer 30B) may be provided.

Although the embodiments of the present disclosure have been described above, the present disclosure is not necessarily limited to the above-described embodiments, and various modifications can be made without departing from the scope of the present disclosure. For example, the planar shape of the coil is not limited to an elliptical annular shape or a rectangular annular shape, and may be an annular shape or a polygonal annular shape. The exposed shape of the coil end portion is not limited to a circular shape or a rectangular shape, and may be an elliptical shape or a polygonal shape.

What is claimed is:

1. A coil component comprising:
an element body made of a magnetic material including metal powder and resin;
a coil provided in the element body, a surface of the coil is covered with an insulator, and both end portions of the coil are extracted to the surface of the element body;
a pair of external terminals provided on the surface of the element body and including connection regions connected to both end portions of the coil; and
an insulating layer interposed between at least one of the external terminals and the element body and formed in an entire region excluding the connection region in a formation region where the external terminal is formed.

2. The coil component according to claim 1, wherein the element body has a mounting surface facing toward a mounting substrate side, the coil component is to be mounted on the mounting substrate, both end portions of the coil are extracted to the mounting surface, and at least a portion of the external terminal is provided on the mounting surface.

3. The coil component according to claim 1, wherein the element body has a mounting surface facing toward a mounting substrate side and a pair of end surfaces facing each other in one direction parallel to the mounting surface, the coil component is to be mounted on the mounting substrate, and both end portions of the coil are extracted to the pair of end surfaces, respectively, and at least a portion of the external terminal is provided on the end surface.

4. The coil component according to claim 1, wherein an insulator covering the surface of the coil is exposed on the surface of the element body and covers an entire circumference of the end portion of the coil on the surface of the element body.

5. The coil component according to claim 4, wherein the insulating layer is in contact with the insulator at the surface of the element body.

6. The coil component according to claim 1, wherein the insulating layer covers a part of the end portion of the coil at the surface of the element body.

7. The coil component according to claim 1, wherein the end portion of the coil protrudes from the element body and extends outward from the external terminal.
